(19) United States
(12) Patent Application Publication
(10) Pub. No.: US 2007/0182370 A1
(43) Pub. Date: Aug. 9, 2007

(54) Battery pack for supplying AC and DC power

(75) Inventors: Huo-Lu Tsai, Taichung Hsien (TW); Joe Yu, Taichung Hsien (TW)

Correspondence Address: PATENTTM.US, P. O. BOX 82788, PORTLAND, OR, 97282-0788, US

(73) Assignee: Huo-Lu TSAI

(21) Appl. No.: 11/343,618

(22) Filed: Jan. 30, 2006

(51) Int. Cl. H02J 7/00

(52) U.S. Cl. 320/112

(57) ABSTRACT

A battery pack for supplying an AC power has a battery pack served as a DC power source, a charging controlling circuit connected to the battery pack, a switching circuit connected to the battery pack, a voltage boosting circuit connected to the charging controlling circuit, a DC/AC converting circuit connected to the voltage boosting circuit and a feedback controlling circuit connected to the DC/AC converting circuit and the voltage boosting circuit and an AC power output terminal. The DC/AC converting circuit converts the high-voltage DC power of the battery pack to AC power and outputs the AC power through the AC power output terminal to supply the power to electrical products and to stabilize the output voltage using the feedback controlling circuit.

### BACKGROUND OF THE INVENTION

1. Field of the Invention

The present invention relates to a battery pack, and more particularly to a battery pack for supplying AC and DC power.

2. Description of Related Art

The electrical technology has been developed very well. Many kinds of the electrical products are widely applied in people's daily life.

For using the AC power-required electrical products in places where the AC power is unavailable often needs an AC power generator. For DC power required electrical product such as a digital camera or a notebook, a battery pack can supply DC power to these products. However, the battery pack is unable to supply an AC power.

To overcome the shortcomings, the present invention provides a battery pack for supplying AC and DC power to obviate or mitigate the aforementioned problems.

### SUMMARY OF THE INVENTION

The main objective of the present invention is to provide a battery pack that can produce AC and DC power.

Another objective of the invention is to provide a battery pack with a feedback controlling circuit to stabilize the output voltage.

To accomplish the foregoing objective, the battery pack in accordance with the present invention comprises a DC power source, a charging controlling circuit, a switching circuit, a voltage boosting circuit, a DC/AC converting circuit and a feedback controlling circuit.

The DC power source supplies a low DC voltage to the charging controlling circuit and the switching circuit.

The voltage boosting circuit is connected to the charging controlling circuit, boosts the low-voltage DC power to high-voltage DC power.

The DC/AC converting circuit is connected to the voltage boosting circuit and has a AC power output terminal, which converts the high-voltage DC power to AC power and output via the AC power output terminal.

The feeding controlling circuit is connected to the voltage boosting circuit and the DC/AC converting circuit to stabilize the output voltage.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a battery pack for supplying AC and DC power in accordance with the present invention;

FIG. 2 is a circuit diagram of the DC/AC converting circuit in FIG. 1;

FIG. 3 is a functional block diagram of the feedback controlling circuit in FIG. 1; and

FIG. 4 is a timing chart diagram of AC Vₒ and the timing switches Ctr1˜Ctr4.

### DETAILED DESCRIPTION OF THE PREFERRED EMBODIMENT

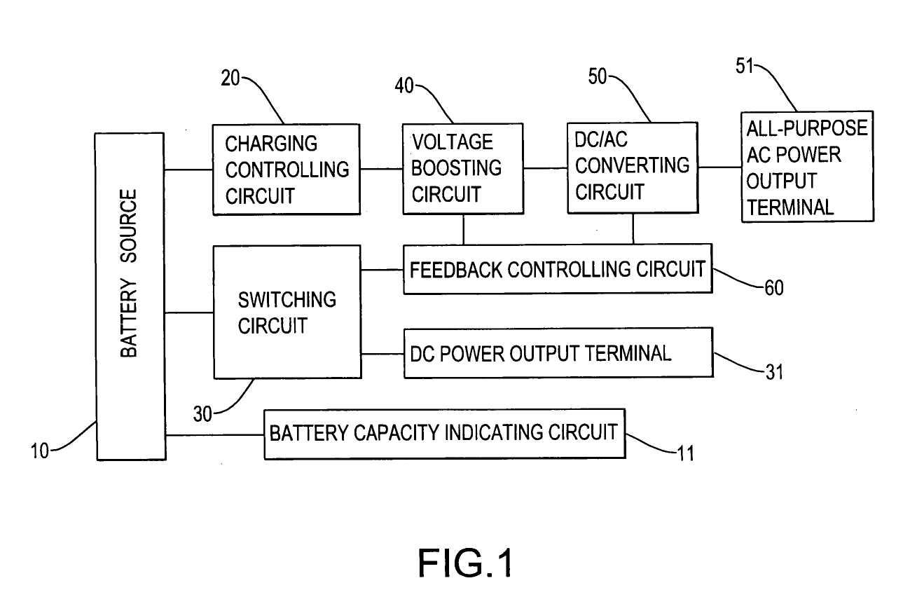

With reference to FIG. 1, a battery pack for supplying AC and DC power in accordance with the present invention comprises a battery source (10), a charging controlling circuit (20), a switching circuit (30), a voltage boosting circuit (40), a DC/AC converting circuit (50) and a feedback controlling circuit (60).

The battery source (10) produces a low DC voltage and connects to a battery capacity indicating circuit (11) to display the remaining electricity in the battery source (10) and information about charging processing.

The charging controlling circuit (20) is connected to the battery source (10) to receive the low DC voltage and supplies a stable current and a stable DC voltage.

The switching circuit (30) is connected to the battery source (10) and connects to a DC power output terminal (31). In this embodiment, the DC power output terminal (31) is a USB connector.

The voltage boosting circuit (40) is connected to the charging controlling circuit (20) to produce a high DC voltage based on the stable DC voltage.

The DC/AC converting circuit (50) is connected to the voltage boosting circuit (40) and connects to an AC power output terminal (51) to convert the high DC voltage to AC power and to supply the AC power through the AC power output terminal (51).

The feedback controlling circuit (60) comprises multiple timing switches Ctr1˜Ctr4 and is connected to the voltage boosting circuit (40) and the DC/AC converting circuit (50) to stabilize the AC power.

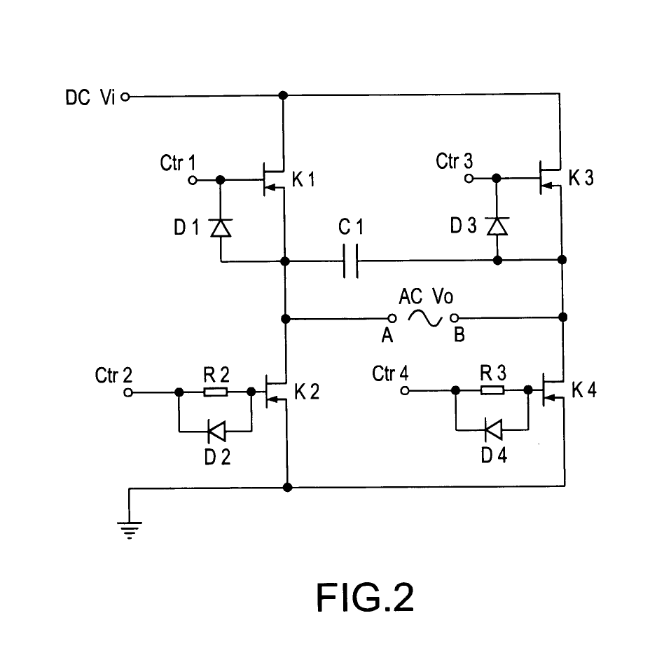

With reference to FIG. 2, the DC/AC converting circuit (50) comprises multiple electrical switches K1˜K4, multiple diodes D1˜D4, a capacitor C1, multiple resistors R2, R3 and two terminals A, B. The two terminals A, B are served as the AC power output terminal (51). The DC/AC converting circuit (50) converts the high DC voltage (DC V1) to the AC power (AC Vₒ) output by the AC power output terminal (51).

Each electrical switch K1˜K4 can be implemented with the MOSFET having a drain, gate and source.

For the electrical switch K1, the drain is connected to the high DC voltage (DC Vᵢ), the gate is connected to the timing switch Ctr1 and the source is connected to the drain of the electrical switch K2.

For the electrical switch K2, the gate is connected to the timing switch Ctr2, the source is connected to ground and the drain is connected to the source of the electrical switch K1.

For the electrical switch K3, the drain is connected to the high DC voltage (DC Vᵢ), the gate is connected to the timing switch Ctr3 and the source is connected to the drain of the electrical switch K4.

For the electrical switch K4, the gate is connected to the timing switch Ctr4, the source is connected to ground and the drain is connected to the source of the electrical switch K3.

The diode D1 has a positive terminal connected to the source of the electrical switch K1 and the drain of the electrical switch K2 and has a negative terminal connected to the gate of the electrical switch K1 and the timing switch Ctr1.

The diode D2 has a positive terminal connected to the gate of the electrical switch K2 and the resistor R2 and has a negative terminal connected to the resistor R2 and the timing switch Ctr2.

The diode D3 has a positive terminal connected to the source of the electrical switch K3 and the drain of the electrical switch K4 and has a negative terminal connected to the gate of the electrical switch K3 and the timing switch Ctr3.

The diode D4 has a positive terminal connected to the gate of the electrical switch K4 and the resistor R3 and has a negative terminal connected to the resistor R3 and the timing switch Ctr4.

When the electrical switches K1 and K3 are switched off, the electric charge accumulated on the electrical switches K1 and K3 are discharged to ground through the diodes D1 and D3 respectively, wherein the two diodes can speed up the discharge of the two switches K1 and K3.

When the electrical switches K2 and K2 are switched off, the electric charge accumulated on the electrical switches K2 and K4 are discharged through the diodes D2 and D4 respectively, wherein the two diodes D2 and D4 can speed up the discharge of the two switches K2 and K4.

The capacitor C1 is connected to the source of the electrical switch K1 and the drain of the electrical switch K2 to stabilize the current of the AC voltage.

The two terminals A, B are connected to the source of the electrical switch K1 and the drain of the electrical switch K2 to stabilize the output AC current.

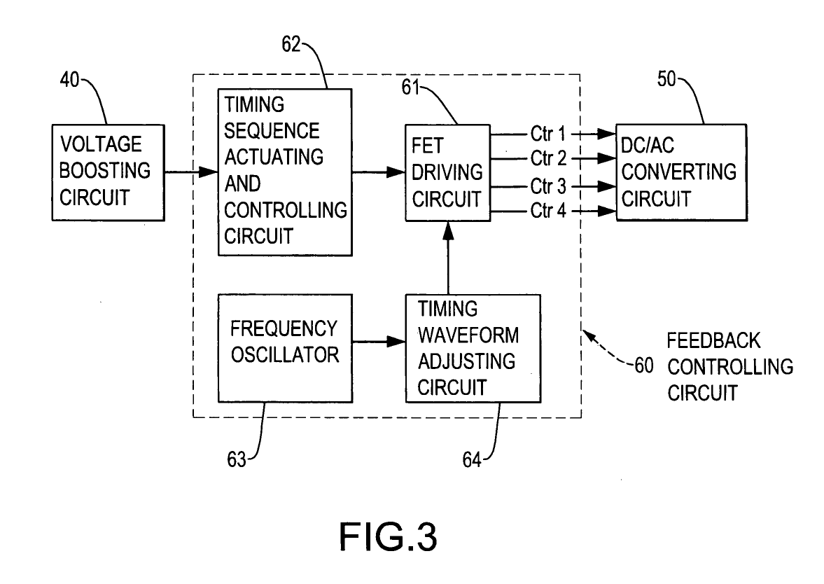

With reference to FIG. 3, the feedback controlling circuit (60) comprises an FET driving circuit (61), a timing sequence determining and controlling circuit (62), a frequency oscillator (63) and a timing waveform adjusting circuit (64).

The FET driving circuit (61) has multiple output terminals and multiple timing switches Ctr1˜Ctr4 connected to the output terminals. The timing switches Ctr1˜Ctr4 connect to the DC/AC converting circuit (50).

The timing sequence determining and controlling circuit (62) is connected between the FET driving circuit (61) and the voltage boosting circuit (40) to control the DC/AC converting circuit (50) through the FET driving circuit (61) to prevent the timing switches Ctr1˜Ctr4 from being simultaneously turned on and to avoid the problem of a short circuit.

The frequency oscillator (63) is connected to the timing waveform adjusting circuit (64) and outputs a constant frequency to the timing waveform adjusting circuit (64) to control the activation of the timing switches Ctr1˜Ctr4. For example, the constant frequency can be 60 Hz or 50 Hz.

The timing waveform adjusting circuit (64) is connected between the frequency oscillator (63) and the FET driving circuit (61). The timing waveform adjusting circuit (64) can adjust the output signal of the frequency oscillator (63) to form signals of different duty cycles. For a complete signal, as an example, the positive half cycle may have 40% duty cycle while the negative half cycle have 60%. The timing waveform adjusting circuit (64) properly controls the driving signals applied to the timing switches Ctr1˜Ctr4. Therefore, the electrical switches K1˜K4 of the DC/AC converting circuit (50) are turned on or turned off according to the operations of the four timing switches to produce an AC power.

Preferably, the feedback controlling circuit (60) further comprises a dead-time controlling circuit (not shown) to prevent short circuit when the high DC voltage is converted to the AC power. It is well known to those person skilled in the art how to implement such circuit.

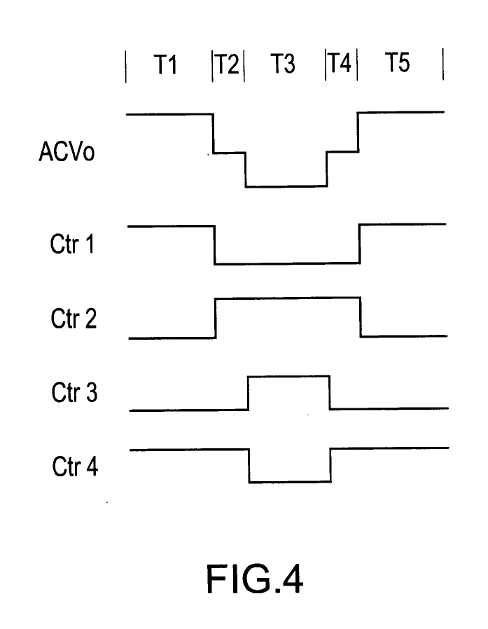

With reference to FIG. 4, original phase of the driving signals timing switch Ctr1 and Ctr3 are opposite to each other. The timing waveform adjusting circuit (64) modifies the driving signal of the timing switch Ctr3 by reducing, for example 5% to 15%, the period of the high-level to form the modified driving signal as illustrated. The phase of the driving signal of the timing switch Ctr2 is opposite to that of the timing switch Ctr1 to prevent the high DC voltage from being contacting to a low voltage terminal such as ground. Similarly, the phase of the driving signal of the timing switch Ctr4 is opposite to that of the timing switch Ctr3.

In T1, the driving signals of the timing switches Ctr1 and Ctr4 are at a high level and the driving signals of the timing switches Ctr2 and Ctr3 are at a low level. The electrical switches K1 and K4 are turned on and the electrical switches K2 and K3 are turned off accordingly. The terminal A of the AC power output terminal (51) is at a high level and the terminal B is connected to ground because of the electrical switch K4, which means the AC power ACVₒ is at a high level (V_{A}>V_{B}).

In T2 and T4, the driving signals of the timing switches Ctr1 and Ctr3 are at a low level and the driving signals of the timing switches Ctr2 and Ctr4 are at a high level. The electrical switches K1 and K3 are turned off and the electrical switches K2 and K4 are turned on accordingly. The terminal A is changed to be connected to ground and the terminal B is also connected to ground. The two terminals A, B are at the same voltage level, which means the AC power ACVₒ is at a zero potential (V_{A}=V_{B}).

In T3, when the driving signals of the timing switches Ctr1 and Ctr4 are at a low level, the driving signals of the timing switches Ctr2 and Ctr3 are at a high level. The electrical switches K1 and K4 are turned off when the electrical switches K2 and K3 are turned on. The terminal A is connected to ground and the terminal B is at a high level, which means the AC power ACVₒ is at a low potential (V_{A}<V_{B}).

During T5, the previous described actions during T1 will be repeated. The repeating frequency of the foregoing operations is 60 Hz or 50 Hz to simulate the sine wave characteristic of an AC power.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A battery pack for supplying an AC and DC power comprising:
a battery source for supplying a low DC voltage;
a charging controlling circuit connected to the battery source to receive the low DC voltage;
a switching circuit connected to the battery source to receive the low DC voltage;
a voltage boosting circuit connected to the charging controlling circuit to boost the low DC voltage to produce a high DC voltage;
a DC/AC converting circuit connected to the voltage boosting circuit to convert the high DC voltage to AC power; and
a feedback controlling circuit connected to the voltage boosting circuit and the DC/AC converting circuit to stabilize the AC power.

2. The battery pack as claimed in claim 1, wherein
the battery source is further connected to a battery capacity indicating circuit to display remaining electricity of the battery source and information related to charging processing; and
the switching circuit further comprises a USB interface port.

3. The battery pack as claimed in claim 2, the DC/AC converting circuit further comprising multiple electrical switches each of which having three terminals, multiple diodes each of which having a positive terminal and a negative terminal, a capacitor and multiple resistors; and
the first, the second and the third terminals of the first electrical switch respectively connected to the high DC voltage, the first timing switch and the first terminal of the second electrical switch;
the second terminal and the third terminal of the second electrical switch respectively connected to the second timing switch and the ground;
the first, the second and third terminals of the third electrical switch respectively connected to the high DC voltage, the third timing switch and the first terminal of the fourth electrical switch;
the second terminal and the third terminal of the fourth electrical switch connected to the fourth timing switch and ground respectively;
wherein the positive terminal of the first diode is connected between the third terminal of the first electrical switch and the first terminal of the second electrical switch, and the negative terminal of the first diode is connected between the second terminal of the first electrical switch and the first timing switch;
wherein the positive terminal of the second diode is connected between the second terminal of the second electrical switch and the two resistors, and the negative terminal of the second diode is connected between the two resistors and the second timing switch;
wherein the positive terminal of the third diode is connected between the third terminal of the third electrical switch and the first terminal of the four electrical switch, and the negative terminal of the third diode is connected between the second terminal of the third electrical switch and the third timing switch;
wherein the positive terminal of the fourth diode is connected between the second terminal of the four electrical switch and the two resistors, the negative terminal of the fourth diode is connected between the two resistors and the four timing switch;
the capacitor being connected between the third terminal of the first electrical switch and the first terminal of the second electrical switch;
the AC power output terminal being connected between the third terminal of the third electrical switch and the first terminal of the four electrical switch.

4. The battery pack as claimed in claim 3, wherein each electrical switch is a MOSFET.

5. The battery pack as claimed in claim 1, wherein the feedback controlling circuit comprises a FET driving circuit, a timing sequence determining and controlling circuit, a frequency oscillator and a timing waveform adjusting circuit;
the FET driving circuit having multiple output terminals and multiple timing switches Ctr1˜Ctr4 connected to the output terminals for connecting the feedback controlling circuit to the DC/AC converting circuit;
the timing sequence determining and controlling circuit being connected between the FET driving circuit and the voltage boosting circuit, controlling the DC/AC converting circuit via the FET driving circuit to prevent the timing switches Ctr1˜Ctr4 from being switched on simultaneously and to avoid a short circuit;
the frequency oscillator being connected to the timing waveform adjusting circuit and outputting a fixed frequency to the timing waveform adjusting circuit to control the timing switches; and
the timing waveform adjusting circuit being connected between the mains frequency oscillator and the FET driving circuit, outputting the signals with different duty cycle to turn the electrical switches of the DC/AC converting circuit on and off via the timing switches of the FET driving circuit to produce the AC power.

6. The battery pack as claimed in claim 3, wherein the feedback controlling circuit comprises a FET driving circuit, a timing sequence determining and controlling circuit, a frequency oscillator and a timing waveform adjusting circuit;
the FET driving circuit having multiple output terminals and multiple timing switches Ctr1˜Ctr4 connected to the output terminals for connecting the feedback controlling circuit to the DC/AC converting circuit;
the timing sequence determining and controlling circuit being connected between the FET driving circuit and the voltage boosting circuit, controlling the DC/AC converting circuit via the FET driving circuit to prevent the timing switches Ctr1˜Ctr4 from being switched on simultaneously and to avoid a short circuit;
the frequency oscillator being connected to the timing waveform adjusting circuit and outputting a fixed frequency to the timing waveform adjusting circuit to control the timing switches; and
the timing waveform adjusting circuit being connected between the mains frequency oscillator and the FET driving circuit, outputting the signals with different duty cycle to turn the electrical switches of the DC/AC converting circuit on and off via the timing switches of the FET driving circuit to produce the AC power.

7. The battery pack as claimed in claim 5, wherein the feedback controlling circuit further comprises a dead-time controlling circuit to provide a time interval between the switching operations of the DC voltage to avoid short circuit.

8. The battery pack as claimed in claim 6, wherein the feedback controlling circuit further comprises a dead-time controlling circuit to provide a time interval between the switching operations of the DC voltage to avoid short circuit.
